(19) United States
(12) Patent Application Publication
(10) Pub. No.: US 2017/0144577 A1
(43) Pub. Date: May 25, 2017

(54) CUP HOLDER FOR VEHICLE

(71) Applicants: Hyundai Motor Company, Seoul (KR); Kia Motors Corporation, Seoul (KR)

(72) Inventors: Man Ju Oh, Yongin (KR); Jae Woo Park, Ansan (KR); Jae Woong Kim, Hwaseong (KR)

(21) Appl. No.: 15/147,064

(22) Filed: May 5, 2016

(30) Foreign Application Priority Data
Nov. 23, 2015 (KR) 10-2015-0164056

(51) Int. Cl. B60N 3/10; H05B 3/26; H05B 3/02

(52) U.S. Cl. CPC B60N 3/104; H05B 3/026; H05B 3/26

(57) ABSTRACT

A cup holder for a vehicle includes an inner cup having a cylindrical shape opened at an upper face thereof to receive a beverage container through the opened upper face and being made of a thermal conductive material; an outer holder surrounding the inner cup while an inner space is defined between the inner cup and the outer holder in a state in which an inner peripheral surface thereof is spaced apart from an outer peripheral surface of the inner cup by a certain distance; a heating element provided in the inner space while one surface of the heating element comes into surface contact with an outside of a bottom of the inner cup; and an elastic body provided beneath the heating element in the inner space, and pressing the heating element upward such that the heating element is pressed against the bottom of the inner cup.

### CROSS REFERENCE TO RELATED APPLICATION

The present application claims under 35 U.S.C. §119(a) the benefit of Korean Patent Application No. 10-2015-0164056 filed on Nov. 23, 2015, the entire contents of which are incorporated by reference herein.

### BACKGROUND

1. Field of the Invention

The present invention relates to a cup holder for a vehicle configured to provide rapid cooling and heating of a beverage container received in the cup holder.

2. Description of the Related Art

In general, vehicles are provided with cup holders for holding beverage containers. These cup holders merely have a gripping function, but there are also some cup holders having a cooling or heating function, in addition to a gripping function, depending on the vehicle model.

However, in order for such a cup holder having a cooling or heating function to effectively exhibit performance, an inner cup portion for receiving a beverage container must be appropriately pressed against a heating element

In addition, when a cup holder is typically mounted onto an armrest in order to improve convenience, accidents such as burns due to a user's carelessness may occur due to characteristics of the cup holder provided in a small space.

The foregoing is intended merely to aid in the understanding of the background of the present invention, and is not intended to mean that the present invention falls within the purview of the related art that is already known to those skilled in the art.

### SUMMARY

The present invention is directed to a cup holder for a vehicle having a structure for effectively coupling a heating element and an inner cup, which transfers heat to a beverage container, and a structure for preventing a safety accident. In particular, the cup holder of the present invention can provide rapid heating and cooling of a beverage container received in the cup holder, thereby improving performance as compared to conventional cup holders with heating and/or cooling functions, and appealing to the user's taste. As provided herein, the cup holder may be provided in conjunction with a vehicle (e.g., a car, sports utility vehicle (SUV), truck, etc.) including a motorized or non-motorized vehicle, but the cup holder is useful in any application in which a cup holder is desirable, e.g., in conjunction with a chair for indoor and/or outdoor use, exercise equipment, etc.

In accordance with one aspect of the present invention, a cup holder for a vehicle includes an inner cup having a cylindrical shape opened at an upper face thereof configured to receive a beverage container through the opened upper face and being made of a thermal conductive material, an outer holder surrounding the inner cup while an inner space is defined between the inner cup and the outer holder in a state in which an inner peripheral surface of the outer holder is spaced apart from an outer peripheral surface of the inner cup by a certain distance, a heating element provided in the inner space between the inner cup and the outer holder while one surface of the heating element comes into surface contact with an outside of a bottom of the inner cup, and an elastic body provided beneath the heating element in the inner space between the inner cup and the outer holder, and pressing the heating element upward such that the heating element is pressed against the bottom of the inner cup.

The inner space between the inner cup and the outer holder may be filled with an insulator.

The cup holder may further include a thermal diffusion member provided between the inner cup and the heating element and having a size corresponding to an area of the bottom of the inner cup, while an upper face of the thermal diffusion member comes into surface contact with the bottom of the inner cup and a lower face thereof comes into surface contact with the heating element.

A thermal grease may be applied between the inner cup and the heating element, so as to fill a gap generated when the heating element comes into surface contact with the outside of the bottom of the inner cup.

The heating element may be a PTC element.

The elastic body may be provided between an upper end of the inner cup and a cup holder housing surrounding the upper end of the inner cup, and apply force downward from the upper end of the inner cup such that the heating element is pressed against the inner cup.

The cup holder may further include a support part supporting a side of a cup during receiving thereof while having a front end protruding from an inside surface of the inner cup and a rear end provided with an elastic part, and a contact sensor provided on the support part to detect whether or not the support part is pressed in a contact manner.

The cup holder may further include a temperature sensor for measuring a temperature of the inner cup.

The cup holder may further include a switch operated by a user's request for operating the cup holder, and a controller for operating the heating element when satisfying both conditions that the switch is operated by the user's request for operating the cup holder and the receiving of the beverage container is detected by the contact sensor.

The inner cup may have a cylindrical shape opened at both upper and lower faces thereof, and the lower face of the inner cup may be coupled to the upper face of the thermal diffusion member so as to be sealed.

As apparent from the above description, the cup holder according to the present invention can cool and heat a beverage so as to suit user's taste, and protect a user from safety accidents such as burns.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a cup holder for a vehicle according to an embodiment of the present invention;

FIG. 2 is a view illustrating a cup holder according to another embodiment of the present invention; and

FIG. 3 is a view illustrating a cup holder according to a further embodiment of the present invention.

### DESCRIPTION OF PREFERRED EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and ^{the} are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The preferred embodiments of the present invention will be described below with reference to the accompanying drawings.

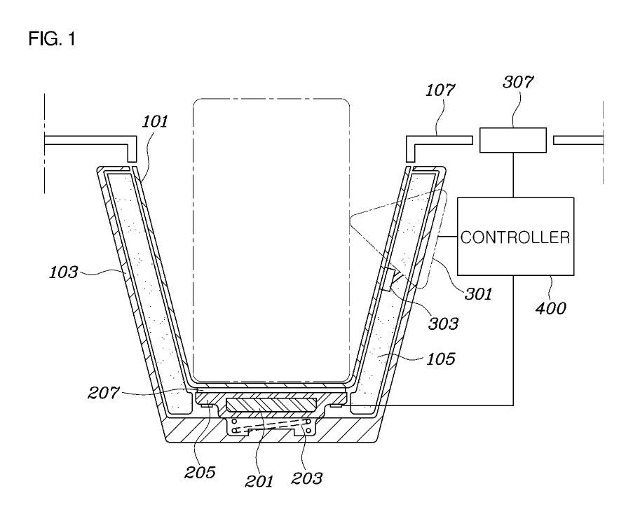

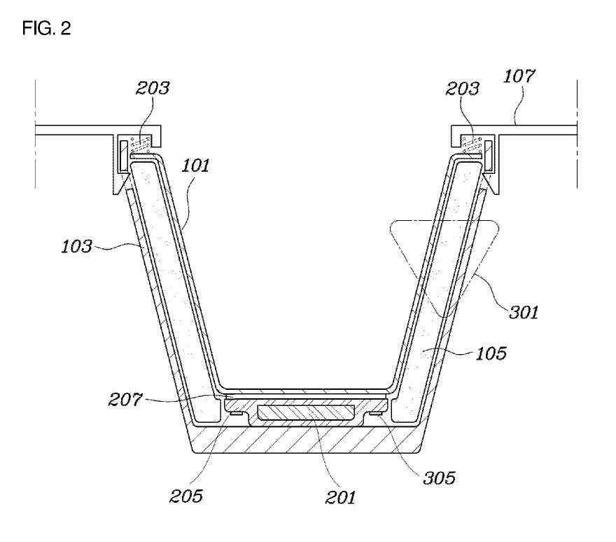

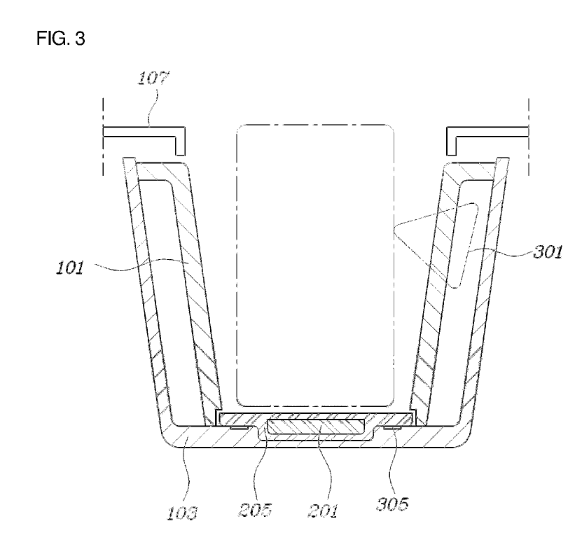

FIG. 1 is a view illustrating a cup holder for a vehicle according to an embodiment of the present invention, and FIGS. 2 and 3 are views illustrating cup holders according to other embodiments of the present invention.

The cup holder according to the embodiments of the present invention includes an inner cup 101 which has a cylindrical shape opened at the upper face thereof so as to receive a beverage container (shown in outline form in FIG. 1) through the opened upper face, and is made of a thermal conductive material, an outer holder 103 which surrounds the inner cup 101 while an inner space is defined between the inner cup 101 and the outer holder 103 in the state in which the inner peripheral surface of the outer holder 103 is spaced apart from the outer peripheral surface of the inner cup 101 by a certain distance, a heating element 201 which is provided in the inner space between the inner cup 101 and the outer holder 103 while one surface of the heating element 201 comes into surface contact with the outside of the bottom of the inner cup 101, and an elastic body 203 which is provided beneath the heating element 201 in the inner space between the inner cup 101 and the outer holder 103, and presses the heating element 201 upward such that the heating element 201 is pressed against the bottom of the inner cup 101.

The elastic body 203 is provided between the upper end of the inner cup 101 and a cup holder housing 107 surrounding the upper end of the inner cup 101, and may apply force downward from the upper end of the inner cup 101 such that the heating element 201 is pressed against the inner cup 101.

The heating element 201 may be a PTC (Positive Temperature Coefficient) element. The inner space between the inner cup 101 and the outer holder 103 may be filled with an insulator 105.

The cup holder according to the embodiments of the present invention basically performs the cooling and heating of a beverage container through thermal conduction from the heating element 201. The heating element 201 may be a PTC element for performing the cooling of the container, and, if necessary, may be a thermoelectric element for performing both cooling and heating of the container depending on electrical characteristics applied thereto. In the embodiments, the case of performing the heating will first be described.

Referring to FIGS. 1 and 2, the inner cup 101 is made of a thermal conductive material, and the outer holder 103 is made of a lower thermal conductive material than the inner cup 101 in order to prevent heat from being unnecessarily lost when the received beverage container is heated. In addition, since the inner space is filled with the insulator 105, it is possible to suppress heat from being unnecessarily lost.

When the heating is performed through thermal conduction, it is most important to secure an area for heat transfer. In particular, if surface contact is not properly made in the thermal conduction, the effect of heat transfer becomes very low. When the surface contact is not properly made, an air layer is formed between a surface and another surface, resulting in a reduction in heat transfer due to the low thermal conductivity of air.

Specifically, stainless steel which may be used as the material of the inner cup 101 has thermal conductivity of 20 W/m·K on average, whereas air has thermal conductivity of 0.025 W/m·K which is about 800 times less than the thermal conductivity of the stainless steel.

Accordingly, the present invention has a structure in which the heating element 201 is pressed by the elastic body 203 for the contact between the inner coup 101 and the heating element 201, as illustrated in FIGS. 1 and 2. The heating element 201 may come into contact with the outside of the bottom of the inner cup 101 by applying force to the heating element 201 using the elastic body 203, or by pressing the inner cup 101 from top to bottom using the elastic body 203.

The cup holder may further include a thermal diffusion member 205, which is provided between the inner cup 101 and the heating element 201 and has a size corresponding to the area of the bottom of the inner cup 101. The upper face of the thermal diffusion member 205 comes into surface contact with the bottom of the inner cup 101, and the lower face thereof comes into surface contact with the heating element 201.

The PTC element which may be used as the heating element 201 of the cup holder of the present invention has various shapes and sizes. The PTC element has better performance in proportion to the size thereof, but this causes an increase in cost.

Accordingly, the present invention includes the thermal diffusion member 205 made of a higher thermal conductive material than the inner cup 101, such that the overall bottom of the inner cup 101 may be uniformly heated even when the PTC element having a smaller size than the area of the bottom of the inner cup 101 is used, as illustrated in FIGS. 1 to 3.

A thermal grease 207 is applied between the inner cup 101 and the heating element 201, and it is thus possible to fill a gap generated when the heating element 201 comes into surface contact with the outside of the bottom of the inner cup 101.

When a surface comes into contact with another surface, it is difficult to perfectly realize the surface contact even though the surfaces are precisely processed, and it is also difficult to eliminate the gap therebetween even though the surfaces are pressed by the elastic body 203 as in the present invention. Thus, the gap between the contact surfaces, as illustrated in FIGS. 1 and 2, may be filled with the thermal grease 207 instead of air by applying it therebetween, thereby increasing thermal conduction efficiency. Since the thermal grease 207 has thermal conductivity of about 4 W/m·K, which is lower than stainless steel but is higher than air having thermal conductivity of 0.025 W/m·K, thermal conduction efficiency is increased.

The cup holder may further include a support part 301 which supports the side of the cup during the receiving thereof while having a front end protruding from the inside surface of the inner cup 101 and a rear end provided with an elastic part, and a contact sensor 303 which is provided on the support part 301 to detect whether or not the support part 301 is pressed in a contact manner.

The cup holder may further include a temperature sensor 305 for measuring the temperature of the inner cup 101.

The cup holder may further include a switch 307 operated by a user's request for operating the cup holder, and a controller 400 which operates the heating element 201 when satisfying both conditions that the switch 307 is operated by the user's request for operating the cup holder and the receiving of the cup is detected by the contact sensor 303.

In order to use the heating function of the cup holder, it is necessary to apply electric power through the switch 307 or the like. However, when the heating function of the cup holder depends on only the operation of the switch 307, the cup holder may be heated due to user's carelessness or unexpected situations despite that the beverage container is not received therein, thereby causing safety accidents such as burns.

Accordingly, in order to prevent safety accidents, it is necessary to control the cup holder such that the heating function of the cup holder is performed only when the beverage container is checked to be received in the cup holder through the configuration of the support part 301 and the switch 307 is operated by the user's request, as illustrated in FIG. 1.

The inner cup 101 has a cylindrical shape opened at both upper and lower faces thereof, and the lower face of the inner cup 101 may be coupled to the upper face of the thermal diffusion member 205 so as to be sealed.

The thermal diffusion member 205 having higher thermal conductivity than the inner cup 101 comes into direct contact with the beverage container, thereby enabling heat transfer efficiency to be increased. Of course, the whole inner cup 101 may also be manufactured of a material having high thermal conductivity as in the thermal diffusion member 205. However, this is not preferable since the durable strength of the cup holder may be problematic and burns may be caused by the excessive heating of the upper end coming into contact with a user's hand. Therefore, the user's bums can be prevented by uniformly heating the wide area of the back surface of the cup holder such that only the back surface comes into contact with the thermal diffusion member 205 having high thermal conductivity, and by manufacturing the rest of the inner cup 101 using stainless steel having relatively low thermal conductivity, as illustrated in FIG. 3.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A cup holder for a vehicle, comprising:
an inner cup having a cylindrical shape opened at an upper face thereof, the inner cup configured to receive a beverage container through the opened upper face and being made of a thermal conductive material;
an outer holder surrounding the inner cup while an inner space is defined between the inner cup and the outer holder in a state in which an inner peripheral surface of the outer holder is spaced apart from an outer peripheral surface of the inner cup by a certain distance;
a heating element provided in the inner space between the inner cup and the outer holder while one surface of the heating element comes into surface contact with an outside of a bottom of the inner cup; and
an elastic body provided beneath the heating element in the inner space between the inner cup and the outer holder, and pressing the heating element upward such that the heating element is pressed against the bottom of the inner cup.

2. The cup holder according to claim 1, wherein the inner space between the inner cup and the outer holder is filled with an insulator.

3. The cup holder according to claim 1, further comprising a thermal diffusion member provided between the inner cup and the heating element and having a size corresponding to an area of the bottom of the inner cup, while an upper face of the thermal diffusion member comes into surface contact with the bottom of the inner cup and a lower face thereof comes into surface contact with the heating element.

4. The cup holder according to claim 1, wherein a thermal grease is applied between the inner cup and the heating element, so as to fill a gap generated when the heating element comes into surface contact with the outside of the bottom of the inner cup.

5. The cup holder according to claim 1, wherein the heating element is a PTC element

6. The cup holder according to claim 1, wherein the elastic body is provided between an upper end of the inner cup and a cup holder housing surrounding the upper end of the inner cup, and applies force downward from the upper end of the inner cup such that the heating element is pressed against the inner cup.

7. The cup holder according to claim 1, further comprising:
a support part supporting a side of the beverage container during receiving thereof while having a front end protruding from an inside surface of the inner cup and a rear end provided with an elastic part; and
a contact sensor provided on the support part to detect whether or not the support part is pressed in a contact manner.

8. The cup holder according to claim 1, further comprising a temperature sensor for measuring a temperature of the inner cup.

9. The cup holder according to claim 7, further comprising:
a switch operated by a user's request for operating the cup holder; and
a controller for operating the heating element when satisfying both conditions that the switch is operated by the user's request for operating the cup holder and the receiving of the beverage container is detected by the contact sensor.

10. The cup holder according to claim 3, wherein the inner cup has a cylindrical shape opened at both upper and lower faces thereof, and the lower face of the inner cup is coupled to the upper face of the thermal diffusion member so as to be sealed.
